(19) United States
(12) Patent Application Publication
(10) Pub. No.: US 2015/0019304 A1
(43) Pub. Date: Jan. 15, 2015

(54) Vehicle Rental Method and System

(71) Applicant: Masoud VAKILI, Los Altos, CA (US)

(72) Inventor: Masoud VAKILI, Los Altos, CA (US)

(21) Appl. No.: 14/263,261

(22) Filed: Apr. 28, 2014

Related U.S. Application Data
(63) Continuation-in-part of application No. 13/562,193, filed on Jul. 30, 2012, now abandoned.

(51) Int. Cl. G07B 15/00; G06Q 20/32

(52) U.S. Cl. CPC G07B 15/00; G06Q 20/322
USPC 705/13

(57) ABSTRACT

Methods and systems for remotely providing a rental vehicle from a rental company to a renter. The rental company may remotely send a smartkey functionality to the mobile device used by the renter. The functionality may be implemented through an application running on the mobile device. At the time of renting a specific vehicle, data related to the rented vehicle may be remotely sent from a server used by the rental company to the mobile device.

### CROSS-REFERENCE TO RELATED APPLICATIONS

The present application is a continuation-in-part of U.S. patent application Ser. No. 13/562,193, filed Jul. 30, 2012, which claims priority to U.S. Provisional Application Ser. No. 61/512,404, filed on Jul. 28, 2011, the disclosures of which are hereby incorporated herein in their entireties.

### FIELD OF THE INVENTION

Various embodiments related to electronic vehicle rental are presented.

### BACKGROUND OF THE INVENTION

Increasingly, one's mobile device, such as a smartphone or other mobile device, plays a more central role in one's life, With technologies like RFID and NFC, combined with longer range telecom networks, various types of applications are believed to become widely used.

### DESCRIPTION OF THE FIGURES

FIG. 1 represents rental process according to some embodiments.

FIG. 2 represents possible application interconnection according to some embodiments.

FIG. 3 represents a variety of rental data used by a rental company according to some embodiments.

### DETAILED DESCRIPTION

The embodiments and implementations described here are only exemplary. It will be appreciated by those skilled in the art that these embodiments may be practiced without certain specific details or with alternative detailed implementation without departing from the scope of the present disclosure.

Embodiments presented here relate methods and systems for electronic vehicle rentals.

There is tremendous benefit in reducing or eliminating the time-consuming interactions and a trip to the rental office while renting a vehicle. Currently, a renter needs to be personally present in a rental office or on the premises and physically receive a key or smartkey to the rental vehicle. The key might be a smartkey that communicates with the vehicle through radio frequency.

In some embodiments, a rental car company may send code over a network to a mobile device belonging to a person who wishes to rent a car. The code may, for instance, run as an application on a smartphone. When the code is run, the mobile device, according to one embodiment, may be configured as a smartkey since it has all the capabilities thereof, such as RF, antenna and power source. The thus configured mobile device (e.g., smartphone, tablet, etc.) may then be used to operate the rental car or vehicle. All other contractual issues may also be addressed and satisfied via the smartphone and the resident applications and codes within the smartphone. Validation and authentication measures may also be built into the smartphone to ensure that the person having the phone is indeed the person who pays for and is under rental contract agreement.

According to an embodiment, the rental come company may cause to install or offer to install an application on a renters mobile device. As part of the validation and installation process, the renter may be asked to provide identification information and unique credential information such as, for example, mobile phone number or mobile device ID to a server used by the rental company.

The application, according to the present embodiments, may be configured to receive data from the rental company that may be used by the application configured to operate the rental vehicle. One or more antennae in the rental car may detect the presence of the mobile device through the application or a related function. This will allow the renter to unlock the vehicle. The one or more antennae then perceive the presence of the mobile device inside the vehicle and allow the renter to operate the vehicle by disengaging the vehicle's electronic immobilizer. As such, the presence of the mobile device enables, say, a start button to become active just like the presence of a smartkey.

According to these embodiments, the presence of the mobile device is sensed in the vicinity of the vehicle for unlocking and inside the vehicle for configuring, starting or operating the rental vehicle via one or several antennae. A radio signal pulse generator, for example, in the mobile device may be used to communicate to the antennae in the vehicles body, which corresponds to the action of an RR transponder in a smartkey.

According to one embodiment, the smartphone eliminates the need for the actual transponder in the smartkey, usually Near Field Communication—(NFC) based, which communicates through access tokens with the electronic immobilizer of the vehicle. This would allow the engine to configure and start.

A graphical user interface may be used in one embodiment to mimic all the buttons on a smartkey via, for example, the touch sensing function on the mobile device. These functions may include lock, unlock, start (on/off), open trunk, etc. All such functions may be displayed using icons on the display and a corresponding action may be performed upon touching any of these icons.

The smartphone may be programmed, in some embodiments, to lock or unlock the vehicle as a function of the distance of the smartphone from the vehicle.

There are many other benefits that may be realized according the embodiments presented herein:
The rental agreement may be performed via an application on the mobile device;
The payment may be performed by an application on the mobile device. A renter may pay for the rented vehicle via a payment function on the mobile device that may be linked to an application provided by the rental company.
The payment function may be linked to the smartkey function and/or the rental agreement function, for instance, via data sharing amongst these applications.
The smartphone itself may be used to identify the renter by taking and sharing an image and/or a photo of the renter.
The smartphone itself may be used to report or claim/disclaim any present damage or prior damage to the rental vehicle by taking and sharing image photos of the vehicle.
The physical place of a rental vehicle may be communicated to the renter through the smartphone using, for instance, email or text, one of the applications, a map interface, or voice messages.
The location and speed of a vehicle may be identified or tracked by the rental company through via location and speed of the mobile device through the mobile network or via enabled GPS functions.
The range of motion of the rental vehicle may be identified by the rental company through the location of the mobile device through the mobile network or via enabled GPS function.
The rental agreement may enable the smartphone's GPS function during the rental period via one of the provided applications.

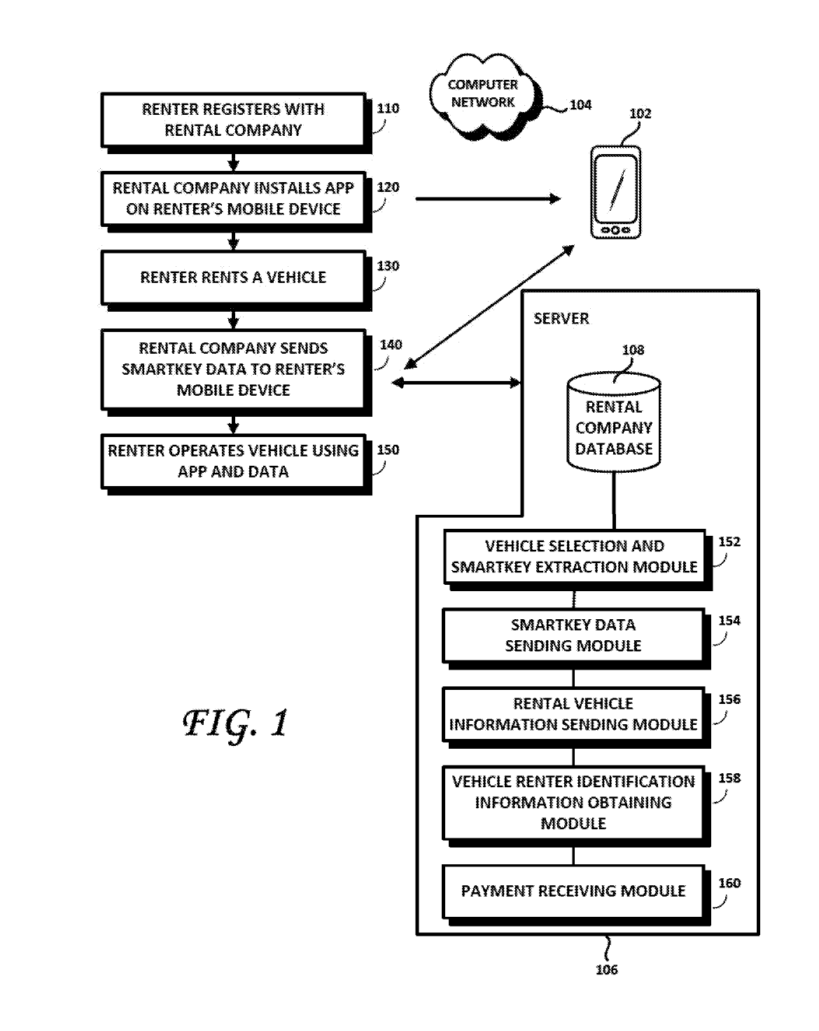

Referring now to FIG. 1, according to one embodiment, at step 110, a renter registers with a rental company. This may include items like singing up, identification, password setting, and full registration. The registration process may also include gathering some preferences or other interest information from a renter which may be used in the future for promotional activities by the rental company. The renter may use a computer or a mobile device 102 to perform this step. However, at least some of the functionality and methods described herein may be best performed using mobile devices.

At step 120, the rental company may offer to install an application on the identified mobile device 102 used by the renter over a computer network, such as shown at 104. The installed mobile app may include, according to one embodiment, general functionalities referred to herein for operating a vehicle rented from the rental company. The functionalities may include, for example, using the mobile device to generate radio signals that are effective to perform or otherwise carry out the functionalities of a smartkey. The renter downloads the application onto his mobile device (or the application is pushed to the renter's mobile device. The renter may then be prompted to agree with terms and conditions of use. Even though all the functionalities may implemented by the application, additional data, specific to a given rental vehicle, may be needed to operate that specific vehicle.

At step 130, a renter decides to rent a vehicle from the rental company. A specific vehicle may then be identified by the rental company that matches the category chosen by the renter at that time or at a later time. The identification of the rental vehicle by the rental company may be based on category only, or such identification may also benefit from user preferences and history that may have been gathered after user registration and profile building, or after every rental transaction.

At step 140, the rental company sends data specific to the rented vehicle to the renter's mobile device from, for example, a server 106 that hosts a database 108 of rental information. This data may include frequency, encryption and rolling code specific to the rented vehicle. When these data are loaded onto the smartkey application, already installed on the mobile device, the mobile device may be configured to act as a smartkey.

According to one embodiment, the rental company may cause the vehicle-specific data to be enabled at a certain time and to expire after the rental vehicle is returned. The rental company may also void the data when the vehicle has not been returned such that the vehicle would not operate after its next stop.

Further, the rental company may communicate information such as the location or position of a rented vehicle, say in a lot or garage, to the renter such that there is no trouble identifying or picking up the car. These data may be displayed through the smartkey application or a related application, text messaging, email, voice messaging, or a graphical map. Other info related to the vehicle such as license plate number, make or color, may also be communicated to the renter in case the renter needs to identify the vehicle then or at a later time. A photo of the vehicle may also be sent to the renter's mobile device to further aid the renter in identifying the vehicle.

At step 150, renter uses the application on his or her smartphone with a user interface to lock, unlock, start and operate the vehicle.

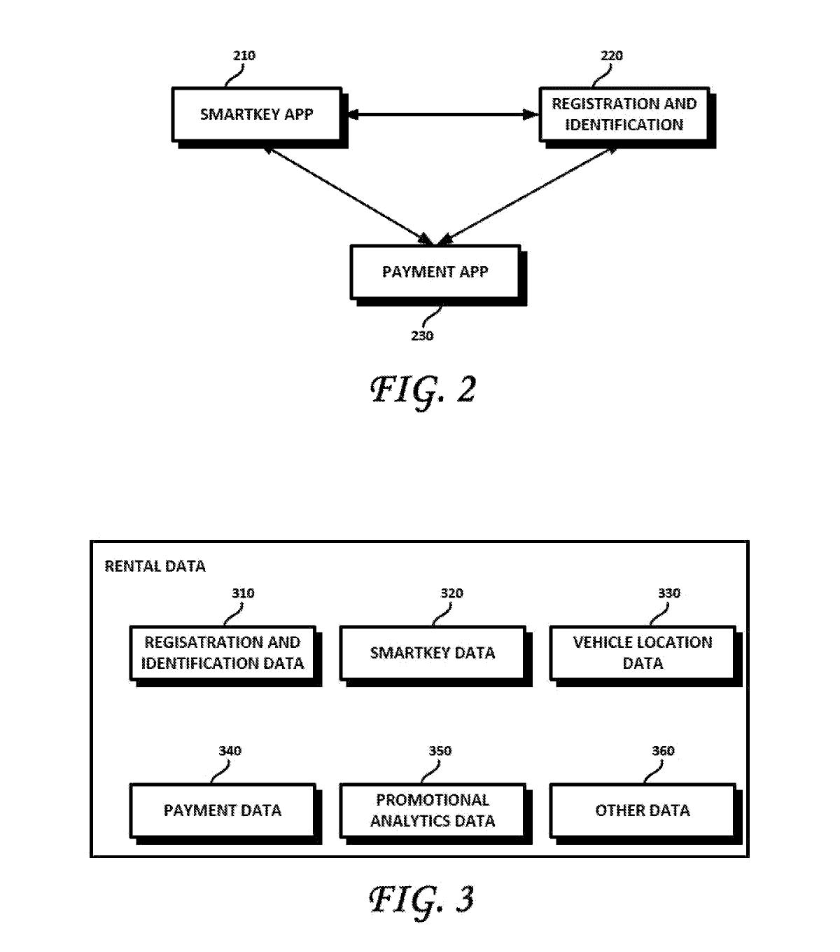

FIG. 2 shows interdependencies of different applications according to one embodiment. A smartkey application 210 may be coupled to a registration and identification application 220, both of which may be coupled to the payment application 230. These applications may share data amongst one another and with other authorized applications.

FIG. 3 shows different types of rental data that may be gathered and used by the rental company. These include registration and identification data 310, smartkey data 320, vehicle location data 330, payment data 340, promotional analytics data 350, and other data 350. These data may be stored on a remote server that is accessible over a computer network and that may be used by the rental company during any rental agreement period and thereafter suitably updated.

According to some embodiments, the rental company may utilize a server or a server farm to manage its rental vehicles. A database, hosted on the server, may be used to link data related to the vehicle including make, model, mileage, rental history, and the smartkey information. The database may be maintained locally, or through private or public cloud. Security measures such as encryption and authentication may be used to protect the data.

A failover mechanism may be used with data mirroring to ensure data recovery. For instance a mirror image of the data may be stored at more than one location, each geographically remote from the others, to disaster-proof the data.

The database may be updated every time a vehicle is rented as well as when it is returned. Optionally, the database may use the position of associated mobile devices in every rented vehicle to monitor and predict rental behavior, inventory, etc.

In some embodiments, to enable security against and in case of misuse of such a feature, when a user is indeed in possession of own mobile device, a renter may receive a notification on the mobile device and a request for further identification and authentication. For example, the renter may be prompted to speak or to enter a PIN.

In some embodiments, a camera on a mobile device may be used to initiate a video call with to the rental company. Alternatively the camera may be used to take certain biometric measures such as a headshot. A camera or a different sensor may be used for fingerprint or retinal scan purposes. All or any of these may be used as security measures to enable or inhibit certain functions.

Certain authentication measures may be pulled by a rental company. For instance, a challenge question such as “whom did you call first this morning” may be asked of the renter to ensure he or she is the true person in possession of the mobile device.

In some embodiments, after authentication, a rental company may pull up a device locator, for instance on a recovery app, to indicate to the user the location of the lost or misplaced mobile device.

Accordingly, some embodiments comprise a method used by a rental company for providing a renter access to a rental vehicle, the method comprising providing smartkey data specific to the rental vehicle from a server used by the rental company to a mobile device used by the renter, which smartkey data is adapted to enable the mobile device to act as a smartkey to operate the rental vehicle.

Other embodiments comprise a system, such as shown in FIG. 1, that may be used by a rental company. The system may comprise a server 106 hosting a database 108. The database 108 may store data related to rental vehicles that may be linked to associated smartkey data. The server and/or the database may comprise, as shown at FIG. 1, a first module 152 to access the database and select a rental vehicle and extract smartkey data related to the rental vehicle, a second module 154 configured to electronically send the smartkey data to a renter, a third module 156 configured to send rental vehicle information to the renter's mobile device, a fourth module 158 to obtain renter identification information and a fifth module 160 configured to receive payment.

While certain embodiments have been described, these embodiments have been presented by way of example only, and are not intended to limit the scope of the inventions. Indeed, the novel devices and systems described herein may be embodied in a variety of other forms. Furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions. For example, those skilled in the art will appreciate that in some embodiments, the actual structures and functionalities disclosed herein may differ from those described herein and shown in the figures. Depending on the embodiment, certain of the structures and/or assembly procedures described in the examples above may be removed, while others may be added. Also, the features and attributes of the specific embodiments disclosed above may be combined in different ways to form additional embodiments, all of which fall within the scope of the present disclosure. Although the present disclosure provides certain embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A method used by a rental company for providing a renter access to a rental vehicle, the method comprising providing smartkey data specific to the rental vehicle from a server used by the rental company to a mobile device used by the renter, which smartkey data is configured to enable the mobile device to act as a smartkey to operate the rental vehicle.

2. The method of claim 1, further comprising providing a smartkey application to be installed on the mobile device used by the renter prior to sending the smartkey data, which smartkey application is configured to use the smartkey data to operate the rental vehicle.

3. The method of claim 2, further comprising providing a registration application to be installed on the mobile device, which registration application is configured to at least validate an identity of the renter.

4. The method of claim 3, further comprising providing a payment function to the mobile device in connection with at least one of the smartkey function and the registration function, to charge the user for use of the rental vehicle.

5. The method of claim 1, wherein the smartkey-configured mobile device enables the renter to lock, unlock, and turn on/off the rental vehicle.

6. The method of claim 1, further comprising providing information about the rental vehicle to the mobile device used by the renter.

7. The method of claim 1, further comprising receiving a prior damage disclaimer from the renter through an image taken by the mobile device.

8. The method of claim 1 further comprising enabling a rental agreement to be executed via the mobile device.

9. The method of claim 1, further comprising causing the smartkey data to be activated on the mobile device at a specific time.

10. The method of claim 1, further comprising causing the smartkey data to expire on the mobile device upon the return of the rental vehicle to the rental company.

11. A system used by a rental company, the system comprising:
a server hosting a database, the database comprising data related to rental vehicles linked to associated smartkey data;
a first module configured to access the database and to select a rental vehicle and to extract from the accessed database smartkey data related to the rental vehicle; and
a second module configured to electronically send the smartkey data to a renter.

12. The system of claim 11, further comprising a third module to electronically send information related to a rental vehicle to a mobile device used by a renter.

13. The system of claim 12, wherein the third module uses at least one of an application, text, voice, or email to send the information.

14. The system of claim 11, further comprising a fourth module configured to obtain renter identification information.

15. The system of claim 11, further comprising an application server configured to upload a smartkey application onto a mobile device, the smartkey application being configured to use the smartkey data to operate the rental vehicle.

16. The system of claim 11, further comprising a payment receiving module coupled to a payment function of the mobile device.
